(19) United States
(12) Patent Application Publication
(10) Pub. No.: US 2015/0083621 A1
(43) Pub. Date: Mar. 26, 2015

(54) Socket and Ratchet Holder

(71) Applicant: Keith Walter Worley, Oklahoma City, OK (US)

(72) Inventor: Keith Walter Worley, Oklahoma City, OK (US)

(21) Appl. No.: 14/487,027

(22) Filed: Sep. 15, 2014

Related U.S. Application Data
(60) Provisional application No. 61/877,896, filed on Sep. 13, 2013.
(60) Provisional application No. 61/937,511, filed on Feb. 8, 2014.
(60) Provisional application No. 61/977,309, filed on Apr. 9, 2014.

(51) Int. Cl. B25H 3/00; B25H 3/06

(52) U.S. Cl. CPC B25H 3/003; B25H 3/06
USPC 206/378

(57) ABSTRACT

The embodiments of the Socket and Ratchet Holder are comprised of a socket body and a strap assembly. The strap assembly is comprised of a longitudinal strap and a cross strap. The socket body is comprised of a plurality of socket apertures. The plurality of socket apertures are comprised of a range of sizes of apertures ranging from a small aperture to a large aperture to accommodate the range of sizes of sockets in a typical socket wrench set. The socket body is comprised of narrow-end loop aperture and a wide-end loop aperture. The socket body is comprised of a wrench aperture so that when the socket wrench is to be stowed, the user secures the socket wrench from the bottom of the socket body into the wrench aperture. The socket body is also comprised of a universal aperture to stow the universal socket joint and the socket extension.

### CROSS-REFERENCE TO RELATED APPLICATIONS

This application is a non-provisional patent application of pending U.S. provisional patent application with Ser. No. 61/877,896 titled “Socket and Ratchet Holder With Flexible Retention Strap” filed on Sep. 13, 2013; pending U.S. provisional patent application with Ser. No. 61/937,511 titled “Socket Holder With Flexible Retention Strap and Concave Top Surface” filed on Feb. 8, 2014; and pending U.S. provisional patent application with Ser. No. 61/977,309 titled “Socket and Ratchet Holding Device With Flexible Retention Member” filed on Apr. 9, 2014. This application claims priority of U.S. provisional patent applications with Ser. Nos. 61/877,896, 61/937,511, and 61/977,309. Further, the entire contents of U.S. provisional patent applications with Ser. Nos. 61/877,896, 61/937,511, and 61/977,309 are herein incorporated by reference.

### STATEMENT REGARDING FEDERALLY SPONSORED RESEARCH OR DEVELOPMENT

None.

### BACKGROUND OF THE EMBODIMENTS

The field of the embodiments is generally hand tools and hand tool organization devices.

The embodiments of the SOCKET AND RATCHET HOLDER is designed to aid in the organization and transport of sockets and a ratchet and also provide storage for other accessories. Often a mechanic or other technician is required to use a ratchet and various sockets to assemble, disassemble or repair mechanical items constructed with nuts and or bolts. This often requires the use of various sockets and a ratchet, as well as other related accessories such as universal swivels or extensions. Often sockets and related accessories can become disorganized or lost during transport. The present invention allows the user to organize and store her sockets in a manner suitable for transport in bag or box along with other tools. Furthermore, the present invention will retain the sockets, ratchet and accessories, when in the closed position, no matter the orientation of the device. This allows for easy and secure storage to enable the user to quickly locate and use his ratchet and sockets.

### SUMMARY OF THE EMBODIMENTS

The embodiments of the Socket and Ratchet Holder are comprised of a socket body and a strap assembly. The strap assembly is comprised of a longitudinal strap and a cross strap. In one embodiment, both the longitudinal strap and the cross strap are manufactured from hook and loop fastener material and are used to secure the socket set components into the socket body. The socket body is comprised of a plurality of socket apertures. The plurality of socket apertures are comprised of a range of sizes of apertures ranging from a small aperture to a large aperture to accommodate the range of sizes of sockets in a typical socket wrench set. The plurality of socket apertures are sized so that the sockets slide in and out of the socket apertures without resistance so that the sockets and be engaged to the socket wrench with one hand. In another embodiment, the socket body is comprised of a mid-point aperture so that the longitudinal strap is more firmly in contact with the socket body and the sockets contained therein. The socket body is comprised of narrow-end loop aperture and a wide-end loop aperture. The socket body is comprised of a wrench aperture so that when the socket wrench is to be stowed, the user secures the socket wrench from the bottom of the socket body into the wrench aperture. The socket body is also comprised of a universal aperture to stow the universal socket joint and the socket extension. The universal socket joint and socket extension are slid into the universal aperture by the user for stowing.

In this respect, before explaining at least one embodiment of the Socket and Ratchet Holder in detail, it is to be understood that the embodiment is not limited in this application to the details of construction and to the arrangements of the components set forth in the following description or illustrated in the drawings. The embodiment or embodiments are capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be used as a basis for the designing of other structures, methods and systems for carrying out the several purposes of the embodiments. Additional benefits and advantages of the embodiments will become apparent in those skilled in the art to which the present embodiments relates from the subsequent description of the preferred embodiment and the appended claims, taken in conjunction with the accompanying drawings. It is important, therefore, that the claims be regarded as including such equivalent constructions insofar as they do not depart from the spirit and scope of the embodiments.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the embodiments of the application which is measured by the claims, nor is it intended to be limiting as to the scope of the embodiments in any way.

### BRIEF DESCRIPTION OF THE DRAWINGS

FIG. 1 is a perspective view of the Socket and Ratchet Holder showing a portion of the hook and look strap assembly.

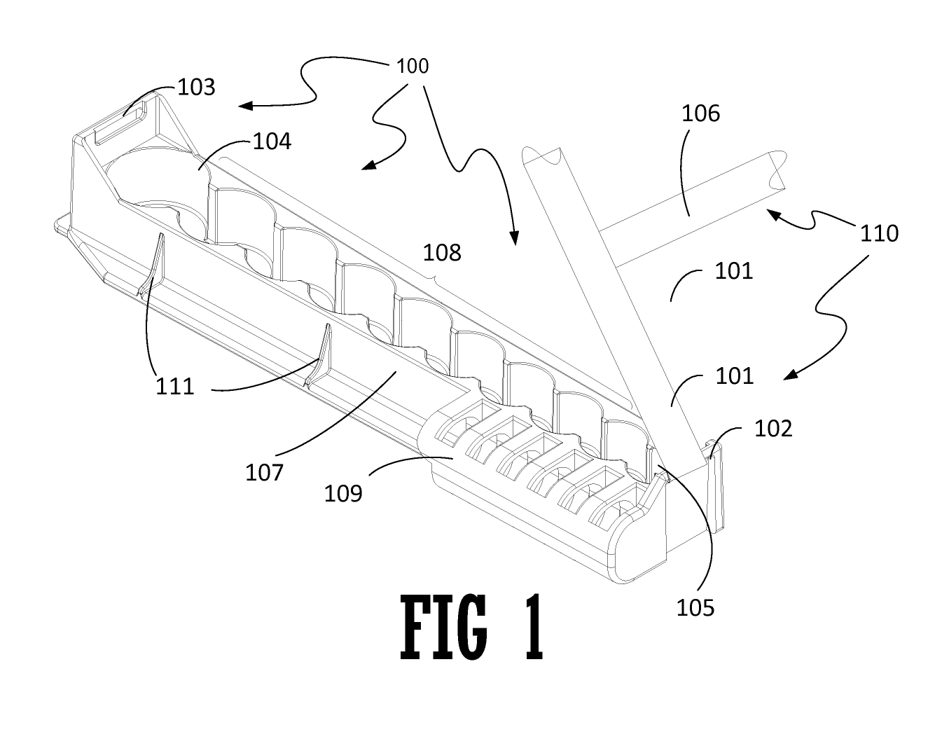

FIG. 2A is a top view of the Socket and Ratchet Holder; FIG. 2B is a side view of the Socket and Ratchet Holder.

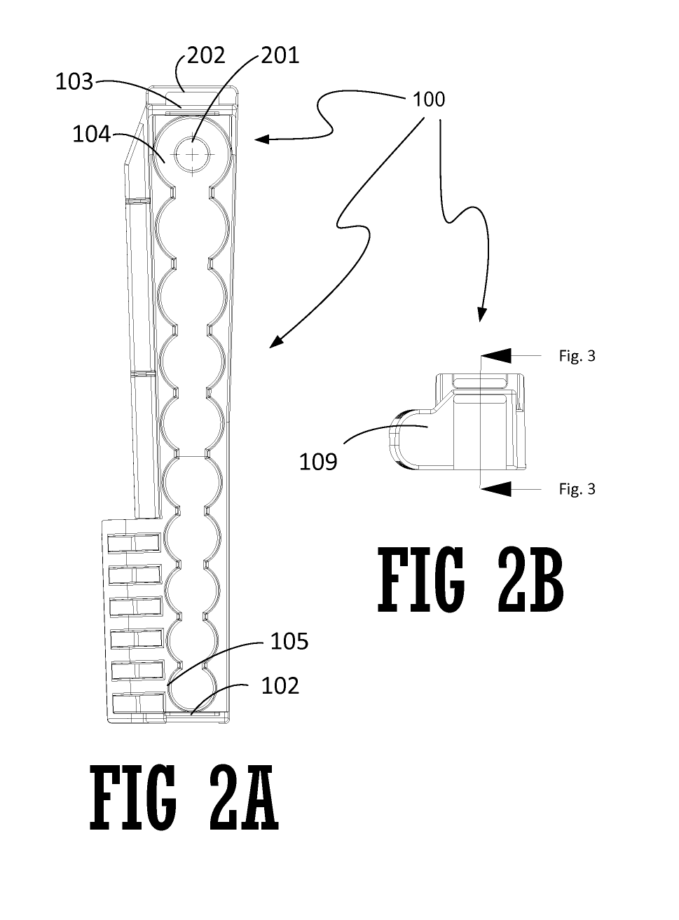

FIG. 3 is a sectional view of the Socket and Ratchet Holder.

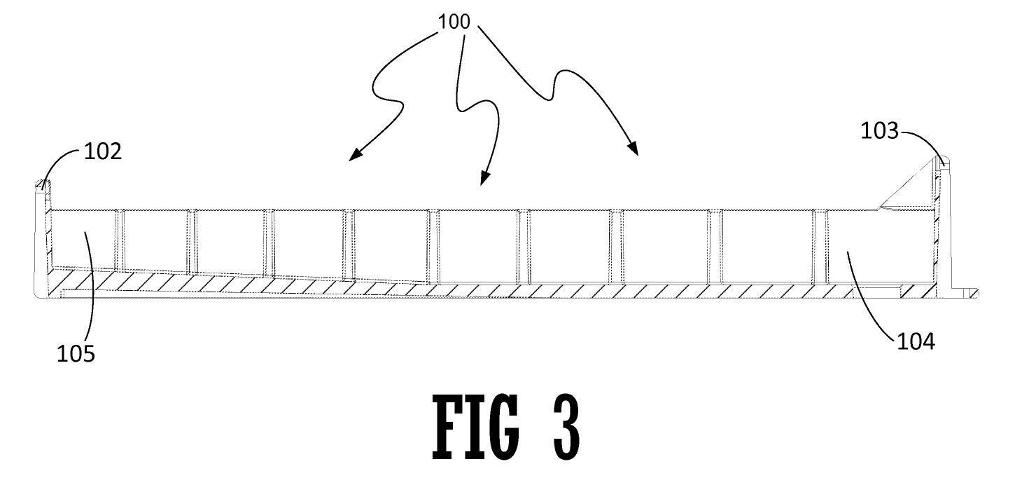

FIG. 4A is a perspective view of the Socket and Ratchet Holder; FIG. 4B is an exploded view of an end of the Socket and Ratchet Holder.

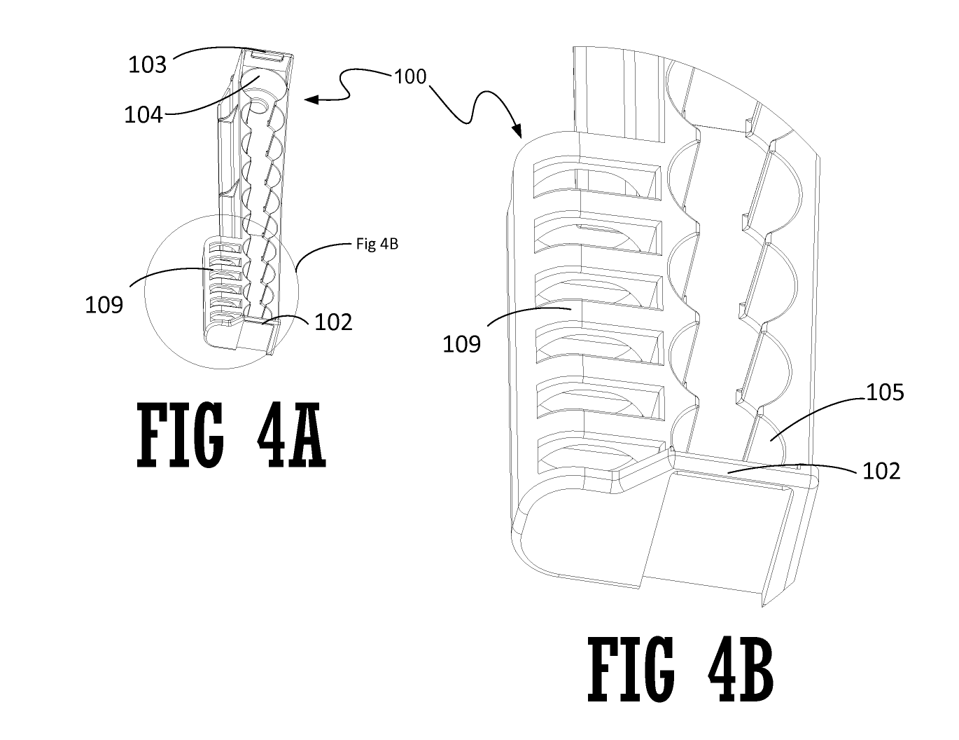

FIG. 5 is a bottom view of the Socket and Ratchet Holder.

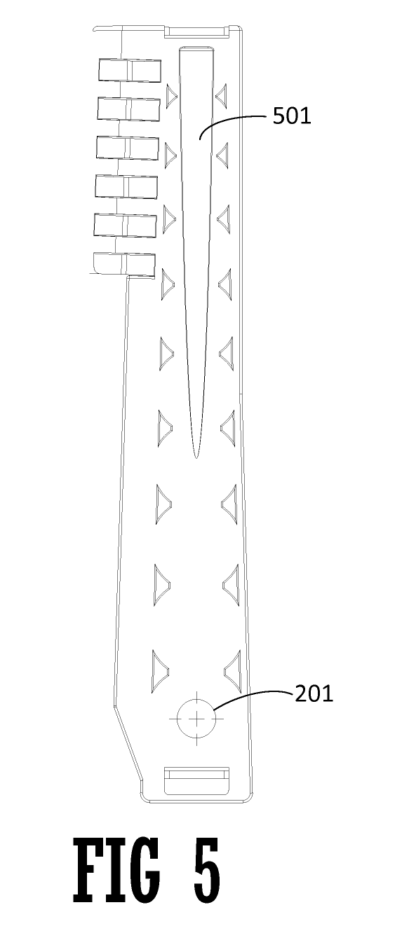

### DETAILED DESCRIPTION OF THE PREFERRED EMBODIMENTS

In an embodiment of the Socket and Ratchet Holder 100, the Socket and Ratchet holder is comprised of a socket body 107 and a strap assembly 110.

The strap assembly 110 is comprised of a longitudinal strap 101 and a cross strap 106. In one embodiment, both the longitudinal strap 101 and the cross strap 106 are manufactured from hook and loop fastener material and are used to secure the socket set components into the socket body 107. In another embodiment the strap assembly 110 is comprised of any flexible material with an attachment means to secure the flexible material back onto itself to secure any sockets that are to be secured by the Socket and Ratchet Holder 100. In an another embodiment the strap assembly is comprised of a rigid material with a fold so that the material folds back onto itself to secure any sockets that are to be secured by the Socket and Ratchet Holder 100. In an embodiment, the strap assembly can be completely removed from the socket body 107. In yet another embodiment the strap assembly is affixed to the socket body 107 via a hook and loop fastener. In yet another embodiment, the strap assembly 110 is comprised of a longitudinal strap 101. In another embodiment. The socket body 107 is comprised of a point mid-point aperture to further secure the longitudinal strap 101 to the socket body 107. The strap assembly 110 will be fabricated in different colors to designate British unit sockets (e.g., red strap assembly) or metric sockets (e.g., blue strap assembly).

The strap assembly 110 is comprised of any strong flexible material that can be fastened onto itself or via a fastener including hook and loop fabric, leather, cloth, rubber, rubberized material, or polymeric material. The term fastener means any fastening means including hook and loop fastening, a buckle, clasp, snap, friction or stretched fastener, magnetic fastener or other means to fasten the flexible material.

The socket body 107 is comprised of a plurality of socket apertures 108. The plurality of socket apertures 108 are comprised of a range of sizes of apertures ranging from a small aperture 105 to a large aperture 104 to accommodate the range of sizes of sockets in a typical socket wrench set. The plurality of socket apertures 108 are sized so that the sockets slide in and out of the socket apertures 108 without resistance so that the sockets can be engaged to the socket wrench with one hand. In another embodiment, the socket body is comprised of a mid-point aperture so that the longitudinal strap 101 is more firmly in contact with the socket body 107 and the sockets contained therein.

The socket body 107 is comprised of narrow-end loop aperture 103 and a wide-end loop aperture 102. The longitudinal strap 101 is secured via the hook and loop fastener by folding the longitudinal strap 101 back onto itself through wide-end loop aperture 102. The other end of the longitudinal strap 101 is threaded through the narrow-end loop aperture 103 by the user when the sockets are to be stored and pulled from the narrow-end loop aperture 103 when the sockets are to be accessed. In yet another embodiment, the longitudinal strap can be inserted through either the wide-end loop aperture 102 or the narrow-end loop aperture 103 permitting the user to accommodate sockets with greater than average depth and permitting one-hand operation.

The socket body 107 is comprised of a wrench aperture 201 so that when the socket wrench is to be stowed, the user secures the socket wrench from the bottom of the socket body 107 into the wrench aperture. The socket body 107 is also comprised of a universal aperture 109 to stow the universal socket joint and the socket extension. The universal socket joint and socket extension are slid into the universal aperture 109 by the user for stowing. The socket body 107 is also comprised of a wrench channel 501. The wrench channel 501 is formed on the bottom of the socket body 107 and serves to cradle the socket wrench and prevent the socket wrench from rotating while in storage. The socket body 107 is comprised of socket extension stops 111 that preclude the universal socket joint and the socket extension from sliding longitudinally. The socket body 107 is comprised of pegboard slot 202 that permits the Socket and Ratchet Holder to be hung on a pegboard hook. In another embodiment, the socket body 107 contains a plurality of socket apertures 108, but no universal aperture 109.

The socket body 107 is constructed so that the bottom portion of the socket body 107 that contains the sockets is slightly angled. This slight angle permits the socket body 107 to have sufficient depth to accommodate the diameter of the universal socket and extension socket in the universal aperture 109. This slightly angled surface also allows for the underside ratchet handle channel 501 to be formed by the socket body 107. This slightly angled surface also allows the smaller sockets at the narrow end of the device to rise out of the top of the aperture area to allow for grasping by the user. This angle feature allows the device to lie flat on the ground and keeps the side mounted universal aperture from having to rise above the top of the socket storage aperture area.

To secure the sockets of the socket set, the sockets are placed in the corresponding socket apertures 108. The longitudinal strap 101, which is permanently attached to the socket body 107 via the wide-end loop aperture 102, is threaded through the narrow-end loop aperture 103 and folded back on itself to secure the hoop and loop fastener. The socket wrench and the universal socket joint are secured by wrapping the cross strap 106 around the socket body, the socket wrench and the universal joint and securing the hook and loop fasteners of the cross strap 106. The cross strap 106 provides downward force at the midpoint of the longitudinal strap 101 so that when the device is inverted the weight of the sockets does not push the longitudinal strap 101 away from the device body and make the sockets susceptible to falling out or being knocked out by another tool in co-storage. In addition, the cross strap 106 secures the extension bar to the side of the case with the extension bar slightly extending into the universal storage aperture thus substantially covering the open end of that aperture so the universal cannot be lost during transport. The cross strap 106 it secures the ratchet to the underside of the device forcing the ratchet handle into the underside channel 501.

What I claim is:

1. A socket and ratchet holder comprised of a socket body and a strap assembly.

2. The socket and ratchet holder described in claim 1 where the strap assembly is comprised of a longitudinal strap and a cross strap.

3. The socket and ratchet holder described in claim 2 where the longitudinal strap and the cross strap are comprised of hook and loop fastener material.

4. The socket and ratchet holder described in claim 2 where the socket body is comprised of a plurality of socket apertures where the plurality of socket apertures are comprised of a range of sizes of apertures ranging from a small aperture to a large aperture to accommodate the range of sizes of sockets in a typical socket wrench set.

5. The socket and ratchet holder described in claim 4 where the plurality of socket apertures are sized so that the sockets slide in and out of the socket apertures without resistance so that the sockets and be engaged to the socket wrench with one hand.

6. The socket and ratchet holder described in claim 5 where the socket body is comprised of narrow-end loop aperture and a wide-end loop aperture.

7. The socket and ratchet holder described in claim 6 wherein to secure the sockets the longitudinal strap is permanently connected to the wide-end loop aperture, and the other end of the longitudinal strap is threaded through the narrow-end loop aperture by the user when the sockets are to be stored and pulled from the narrow-end loop aperture when the sockets are to be accessed.

8. The socket and ratchet holder described in claim 7 wherein the socket body is comprised of a wrench aperture and a universal aperture wherein so that when the socket wrench is to be stowed, the user secures the socket wrench from the bottom of the socket body into the wrench aperture, and wherein the universal aperture is capable of stowing a universal socket joint from a standard socket set.
